(19) United States
(12) Patent Application Publication
(10) Pub. No.: US 2005/0283471 A1
(43) Pub. Date: Dec. 22, 2005

(54) Multi-tier query processing

(75) Inventor: Rafi Ahmed, Fremont, CA (US)

Correspondence Address: HICKMAN PALERMO TRUONG & BECKER, LLP, 2055 GATEWAY PLACE, SUITE 550, SAN JOSE, CA, 95110, US

(73) Assignee: ORACLE INTERNATIONAL CORPORATION, REDWOOD SHORES, CA (US)

(21) Appl. No.: 10/874,400

(22) Filed: Jun. 22, 2004

(51) Int. Cl. G06F 17/30

(52) U.S. Cl. 707/4

(57) ABSTRACT

Techniques are provided for processing a query including determining a first cost based on the original query; if the query has a subquery, generating a second query with the subquery unnested; determining a second cost based on the second query; determining whether the second query includes a mergeable view; and if the second query includes a mergeable view, then generating a third query with the view merged; determining a third cost based on the third query; and choosing an output query from among the set of semantically equivalent queries based on costs associated with the semantically equivalent queries, where the set of semantically equivalent queries includes two or more of the original query, the second query, and the third query.

### RELATED APPLICATIONS

This application is related to U.S. patent Ser. No. ______, entitled “Determining Query Cost Based On A Subquery Filtering Factor”, filed by Rafi Ahmed on ______ (Attorney docket no. 50277-2466), the contents of which are herein incorporated by reference for all purposes as if originally set forth herein, referred to herein as to '2466.

This application is related to U.S. patent Ser. No. ______, entitled “Reusing Optimized Query Blocks In Query Processing”, filed by Rafi Ahmed on ______ (Attorney docket no. 50277-2467), the contents of which are herein incorporated by reference for all purposes as if originally set forth herein, referred to herein as to '2467.

This application is related to U.S. patent Ser. No. ______, entitled “Selecting Candidate Queries”, filed by Rafi Ahmed on ______ (Attorney docket no. 50277-2469), the contents of which are herein incorporated by reference for all purposes as if originally set forth herein, referred to herein as to '2469.

### FIELD OF THE INVENTION

The present invention relates to query processing. The invention relates more specifically to multi-tier query processing.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Relational database management systems store information in tables, where each piece of data is stored at a particular row and column. Information in a given row generally is associated with a particular object, and information in a given column generally relates to a particular category of information. For example, each row of a table may correspond to a particular employee, and the various columns of the table may correspond to employee names, employee social security numbers, and employee salaries.

A user retrieves information from and makes updates to a database by interacting with a database application. The user's actions are converted into a query by the database application. The database application submits the query to a database server. The database server responds to the query by accessing the tables specified in the query to determine which information stored in the tables satisfies the query. The information that satisfies the query is retrieved by the database server and transmitted to the database application. Alternatively, a user may request information directly from the database server by constructing and submitting a query directly to the database server using a command line or graphical interface.

Queries submitted to the database server must conform to the syntactical rules of a particular query language. One popular query language, known as the Structured Query Language (SQL), provides users a variety of ways to specify information to be retrieved. In SQL and other query languages, queries may have query block. Subqueries and views are each a type of “query block”. For example, the query
SELECT L1.1_extendedprice
FROM lineitem L1, parts P
WHERE P.p_partkey=L1.1_partkey AND P.p_container=‘MED BOX’
   AND L1.1_quantity<(SELECT AVG (L2.1_quantity)
      FROM lineitem L2
      WHERE L2.1_partkey=P.p_partkey);
         has a subquery:
(SELECT AVG (L2.1_quantity)
FROM lineitem L2
WHERE L2.1_partkey=P.p_partkey)

A database server may estimate the cost of executing a query, either in terms of computing resources or response time. For a query that has one or more subqueries, there may be multiple possible execution plans or paths for the query. For example, the subqueries may be unnested. Generally, unnesting involves transformation in which (1) the subquery block is merged into the containing query block of the subquery or (2) the subquery is converted into an inline view.

An approach to deciding among these semantically equivalent alternatives to the query is the heuristic approach. In the heuristic approach, a set of rules, or “heuristics,” are applied to the query and the data on which the query will execute. The results of applying the heuristics to the query and the data result in choosing one among various semantically equivalent forms of the query. A problem with the heuristic approach is that decisions are made based on broad sets of rules, these rules may not be correct for the query in question, and the heuristics may cause a semantically equivalent query to be chosen even if its cost is higher than one or more of the other semantically equivalent queries.

Therefore, there is clearly a need for techniques that overcome the shortfalls of the heuristic approaches described above.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that depicts a system for multi-tier query processing.

FIG. 2A is a flow diagram that depicts a process for executing queries.

FIG. 2B is a flow diagram that depicts a process for multi-tier query processing.

FIG. 3 is a flow diagram that depicts a process for multi-tier query processing for queries with multiple subqueries.

FIG. 4 is a block diagram that illustrates a computer system upon which an embodiment of the invention may be implemented.

### DETAILED DESCRIPTION OF THE INVENTION

A method and apparatus for multi-tier query processing is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview

The techniques described herein enable estimation of the costs for multiple semantically equivalent queries, which may be determined by performing one or more transformations on the original query, and choosing one of the semantically equivalent queries based on the costs. The one or more transformations may be performed in sequence, resulting in multiple “tiers” of transformations or “interleaved” transformations. First, the query is processed in order to determine whether it has any subqueries. If the query does have a subquery, then the costs for the query, (1) with the subquery “nested” in the untransformed original form and (2) with the subquery unnested, are determined. If the unnesting produces a mergeable view, then a cost is estimated for a semantically equivalent query (3) with the view merged. If there are multiple subqueries, then this cost estimation operation may be done for all possible combinations of subquery unnesting and view merging or for a representative subset thereof. Each of the possible combinations will produce a semantically equivalent query. In general, any appropriate cost function may be used and any appropriate unnesting algorithm and view-merging algorithm may be used.

Performing view-merging transformation on an inline view that was generated by the performing of an unnesting transformation, may be termed, in general a “multi-tier transformation,” and, specifically, an “interleaved transformation.” The cost of a semantically equivalent query with a query block unnested may have a higher cost than that of the original untransformed query. However, the cost of a semantically equivalent query produced by unnesting the query block and merging an inline view that resulted from the unnesting into the outer query may have a lower cost than the original query and a lower cost than the query with the query block unnested.

Once the costs are determined, then the semantically equivalent query with the lowest cost is chosen. If these techniques are executing as part of a query execution unit, then the chosen query is executed and results are produced.

System Overview

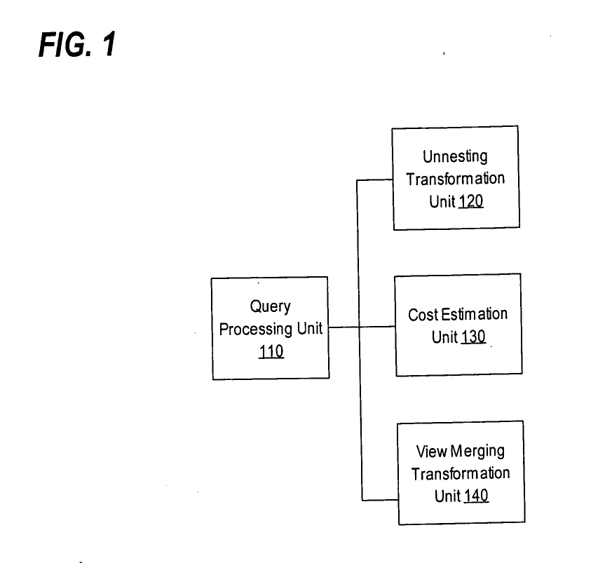

FIG. 1 is a block diagram that depicts a system for multi-tier query processing.

FIG. 1 depicts four logical machines: a query processing unit 110, an unnesting transformation unit 120, a cost estimation unit 130, and a view merging transformation unit 140. Each logical machine may run on separate physical computing machines or may be running on the same physical computing machine as one or more of the other logical machines. Various embodiments of computers and other physical and logical machines are described in detail below in the section entitled Hardware Overview.

The query-processing unit 110 is communicatively coupled to the unnesting transformation unit 120, the cost estimation unit 130, and the view merging transformation unit 140. In various embodiments, each of the unnesting transformation unit 120, cost estimation unit 130, and the view merging transformation unit 140 may also each be communicatively coupled to one or more of each of the other two units 120, 130, and 140. In various embodiments, coupling is accomplished by optical, infrared, or radio signal transmission, direct cabling, wireless networking, local area networks (LANs), wide area networks (WANs), wireless local area networks (WLANs), the Internet, or any appropriate communication mechanism.

In the example herein, the unnesting transformation unit 120 provides, for a particular query that contains a subquery, an output query with the subquery unnested. The cost estimation unit 130 estimates the response time, central processing unit (CPU), or I/O costs for an input query. The view merging transformation unit 140 takes as input a query with a mergeable view, which either may be produced by the previous unnesting transformation or is present in the original query, and merges the view to produce an output query. The query-processing unit 110 uses the unnesting transformation unit 120, the cost estimation unit 130, and the view merging transformation unit 140 to process queries that have one or more subqueries.

In one embodiment, each of the query-processing unit 110, the unnesting transformation unit 120, the cost estimation unit, and the view merging transformation unit 140 runs as part of a database server. The database may be a single node or multiple node database server and may be an object-oriented database server, a relational database server, or any other structured data server.

Estimating Query Cost

There are numerous methods for estimating the cost of a query. The techniques described herein are in no way limited to any particular type or types of estimation methods. Example techniques for estimating query costs are described in (1) “Access Path Selection in a Relational Database Management System” P. G. Selinger, et al., ACM SIGMOD, 1979; (2) “Database System Implementation”, H. Garcia-Molina, et al., Prentice Hall, 2000; and (3) “Query Evaluation Techniques for Large Databases”, G. Graefe, ACM Computing Surveys, 1993.

Subquery Unnesting Transformation

Subquery unnesting may include determining a semantically equivalent version of a query in which the filtering of data produced by one or more subqueries within the query is effectively produced by introducing additional SQL join terms in the outer query. Generally, unnesting involves transformation in which (1) the subquery block is merged into the containing query block of the subquery or (2) the subquery is converted into an inline view. For example, some SQL IN or SQL ANY subqueries may be unnested by converting the subquery into an inline DISTINCT view or into an inline GROUP BY view. For a specific example, in the query listed in the section entitled Background, unnesting the subquery may result in:
SELECT L1.1_extendedprice
FROM lineitem L1, parts P,
   (SELECT AVG(L2.1_quantity) AS LAVG, L2.1_partkey AS L_PKEY
   FROM lineitem L2
   GROUP BY L2.1_partkey) V
WHERE P.p_partkey=L1.1_partkey AND P.p_container=‘MED BOX’
   AND P.p_partkey=V.L_PKEY AND and L1.1_quantity<V.LAVG;

The techniques described herein are in no way limited to any particular type or types of unnesting methods. Various embodiments of unnesting techniques are given in (1) “Of Nests and Trees: A Unified Approach to Processing Queries that Contain Nested Subqueries, Aggregates and Quantifiers”, U. Dayal, 13th VLDB Conf. 1987; and (2) “Extensible/Rule Based Query Rewrite Optimization in Starburst”, Pirahesh, et al., ACM SIGMOD, 1992.

View Merge Transformation

For queries that have had subqueries unnested, the unnesting process may result in the generation of a new inline view in the query. Depending on the technique or techniques used to unnest a subquery, it may produce a semi-joined, anti-joined or regular-joined inline views in the outer query. The original query may also reference inline or predefined views. These views in a query may be mergeable. In various embodiments, mergeable views may include those views that contain an aggregation function (e.g., MAX, MIN, COUNT, AVG, SUM), and, in the context of SQL, a SQL DISTINCT keyword, or a SQL GROUP BY clause. Other views may also be mergeable. The techniques described herein are in no way limited to any particular type or types of view merging. Example embodiments of view merging are given in (1) “Of Nests and Trees: A Unified Approach to Processing Queries that Contain Nested Subqueries, Aggregates and Quantifiers”, U. Dayal, 13th VLDB Conf. 1987; and (2) “Extensible/Rule Based Query Rewrite Optimization in Starburst”, Pirahesh, et al., ACM SIGMOD, 1992.

An example of merging a view, in the context of the example given above, is
SELECT L1.1_extendedprice
FROM lineitem L1, parts P, lineitem L2
WHERE L1.1_partkey=P.p_partkey AND
   P.p_container=‘MED BOX’
   AND L2.1_partkey=P.p_partkey
GROUP BY L2.1_partkey, L1.1_quantity, L1.rowid, P.rowid,
   L1.1_extendedprice HAVING L1.1_quantity<AVG (L2.1_quantity);
      Functional Overview

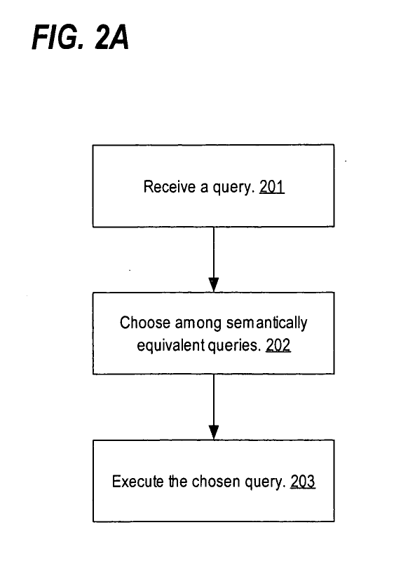

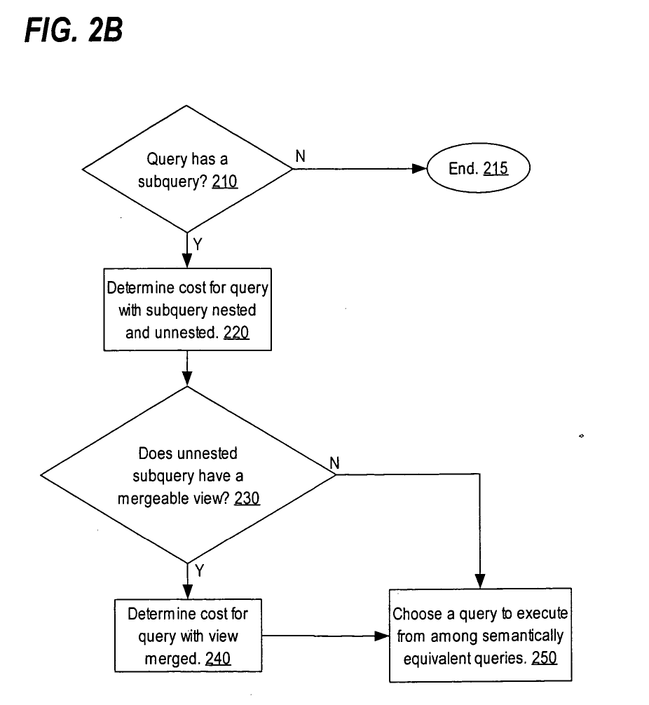

FIG. 2A is a flow diagram that depicts a process for executing queries.

In step 201, a query is received. The query may be received from any appropriate source. For example, a user may submit a query via operation of a database application.

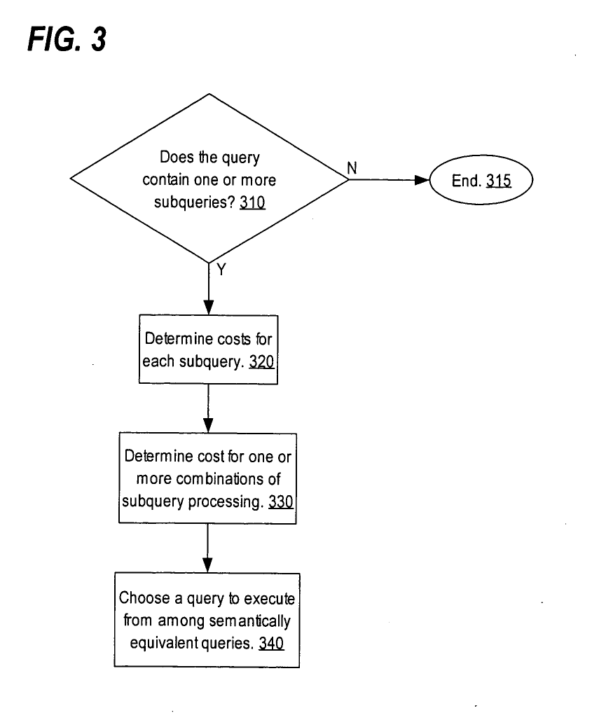

In step 202, costs are estimated for each of a plurality of semantically equivalent queries, which may include the originally received query. Based on the cost estimates a choice is made among the numerous semantically equivalent queries. Numerous possible methods for choosing a query based on cost may be used. Depending on implementation, one query among all of the semantically equivalent queries may be chosen based on processing cost, temporal cost, or both. FIG. 2B and FIG. 3 depict processes for choosing a query based on cost.

In step 203, the chosen query is executed. Since the queries which may be executed are all semantically equivalent, the same end result would be produced by each. Since, in step 202, the query with the lowest cost is chosen, the chosen query will efficiently produce the query results.

FIG. 2B is a flow diagram that depicts a process for multi-tier query processing.

In step 210, a check is performed to determine whether a query has a subquery. The check may be performed by parsing the query or by accessing a machine-readable medium that contains a logical representation of the query. For example, in the context of FIG. 1, a query-processing unit 110 performs a check on a query to determine whether the query has a subquery.

If the query does not have a subquery, then the process of FIG. 2B is terminated in step 215. Terminating the process of FIG. 2B may comprise executing one or more other processes related to processing or executing the query.

If it is determined in step 210 that the query does have a subquery, then in step 220, costs for the query, (1) in its original untransformed form and (2) with the subquery unnested, are determined. Determining the cost of the query in its original form may include having a cost estimation unit estimate the cost for the query. Estimating the cost of the unnested version of the query may comprise, first, performing unnesting transformation on the subquery in the original query, and, second, estimating the cost of the unnested version of the query. Examples of estimating cost are described in the section entitled Estimating the Cost of a Query. Examples of unnesting a subquery are described in the section entitled Subquery Unnesting Transformation. For example, in the context of FIG. 1, a query-processing unit 110 determines the cost of a query in its original form by having a cost estimation unit 130 estimate the cost of the query; and after the unnesting transformation unit 120 determines a version of the query with the subquery unnested, the query processing unit 110 determines the cost of the unnested version of the query by having the cost estimation unit 130 estimate the cost of the unnested version of the query.

In step 230, a check is performed to determine whether the unnested version of the query contains a mergeable view. A mergeable view is any view for which techniques exist to merge the view into the outer query. The mergeability of a view may be based on the view merge techniques used. This is discussed more in the section entitled View Merge Transformations.

If the unnested version of the query includes a mergeable view, then in step 240, a cost for the query with the mergeable view merged is determined. Determining the cost of the query with the mergeable view merged may include performing a view merge transformation on the query to produce a merged version of the query and estimating the cost of the merged version of the query. Examples of performing a view merge transformation are described above in the section entitled View Merge Transformation. For example, in the context of FIG. 1, a query-processing unit 110 determines that an unnested version of a query includes a mergeable view. The query processing unit 110 then has the view merging transformation unit 140 determine a merged version of the query and has the cost estimation unit 130 estimate the cost of the merged version of the query.

Once the costs for each of the semantically equivalent queries are determined in steps 220 and, possibly 240, then in step 250, the version of the query with the lowest cost is chosen. In one embodiment, the version of the query with the lowest cost is chosen for later execution on a database. For example, in the context of FIG. 1, the query-processing unit 110 chooses the version of the query from among the original version, the unnested version, and the merged version. The query-processing unit 110 may later cause the chosen query to be executed on a database.

FIG. 3 is a flow diagram that depicts a process for multi-tier query processing for queries with multiple subqueries.

In step 310, a check is performed to determine whether a query contains one or more subqueries. Various embodiments of checking for subqueries are described above with respect to step 210. If the query does not have a subquery, then the process of FIG. 3 is terminated in step 315. Terminating the process of FIG. 3 may comprise executing one or more other processes related to processing or executing the query. For example, in the context of FIG. 2A terminating the process of FIG. 3 may comprise performing step 203.

If the query contains one or more subqueries, then in step 320, costs are determined for the various semantically equivalent versions of the query, which are arrived at by performing one or more combinations of transformations on one or more of the subqueries. In various embodiments, the costs of semantically equivalent queries with all of the possible combinations of transformations performed on the subqueries are determined (the “exhaustive approach”). In other embodiments, the costs of equivalent versions with a subset of all of the possible combinations of possible transformations performed on the subqueries are determined. Various embodiments of determining costs for semantic equivalent queries are described above with respect to FIG. 2B. The exhaustive approach, linear approaches, and other candidate query selection techniques are described in more detail in '2469.

In one embodiment, the costs for one or more semantically equivalent queries with one or more subqueries unnested are determined. Subsequently, if the unnesting process resulted in the inclusion of an inline view in any semantically equivalent query, then costs are determined for one or more semantically equivalent queries with the inline views merged. If the original query contained one or more inline views, then semantically equivalent queries with one or more of the originally-included inline views merged may also be determined. For example, if there are two subqueries in the original query and each, when unnested, results in inclusion of a mergeable view, then there are nine possible combinations of the two subqueries for which costs may be determined. See, for example, the table below in which “Nested” refers to the subquery appearing in its original form, “Unnested” refers to the subquery that undergoes unnesting transformation in the outer query, and “Unnested-Merged” refers to a view being produced by the unnesting operation and the view undergoing a view-merging transformation in the outer query.

| Choice | | |
|---|---|---|
| Number | Subquery 1 | Subquery 2 |
| 1 | Nested | Nested |
| 2 | Nested | Unnested |
| 3 | Nested | Unnested-merged |
| 4 | Unnested | Nested |
| 5 | Unnested | Unnested |
| 6 | Unnested | Unnested-merged |
| 7 | Unnested-merged | Nested |
| 8 | Unnested_merged | Unnested |
| 9 | Unnested-merged | Unnested-merged |

In a “linear” approach, the cost for an equivalent version is determined, where in the equivalent version each particular subquery undergoes a transformation (among nested, unnested, and unnested-merged) independent of the transformation of the rest of the subqueries. Further, the query chosen in step 340 is the semantically equivalent query that has the lowest cost versions of each of the various transformations of the original query. The linear approach may be beneficial since fewer costs need to be determined than for the exhaustive approach. In one example, where N=number of subqueries and A=maximum number of possible transformations for each subquery, the linear approach would have O(N*A) equivalent queries whose costs are to be determined, and the exhaustive approach would have O(N^{A}) equivalent queries whose costs are to be determined. The reduction in the number of alternative queries whose costs need to be determined in the linear approach may save time or computing resources and thus improve the performance of the query. However, it may be beneficial to use the exhaustive approach, especially in cases where the subqueries are not independent of each other. In that case, the exhaustive approach may be beneficial since it will try all possible semantically equivalent versions and, therefore, may find lower cost query than would the linear approach.

Once the costs for one or more combinations of subquery unnesting transformation are determined, the one with the lowest cost may be selected in step 340. Herein, a lower cost is described as more desirable, and therefore the semantically equivalent query with the lowest cost is chosen. However, in another embodiment, a higher cost function may be more desirable and therefore a semantically equivalent query with a higher cost may be chosen.

An example of steps 330 and 340, with respect to FIG. 1 and FIG. 2A, includes a query-processing unit 110 determining the costs for semantically equivalent queries for a query with multiple subqueries using the exhaustive approach. Once the semantically equivalent query with the lowest cost is determined, then the one with the lowest cost is selected for processing in step 203.

Various embodiments of FIG. 2A, FIG. 2B, and FIG. 3 enable the determination of semantically equivalent queries based on the unnesting of subqueries and the merging of views created by unnesting the subqueries. Once it is determined which of the semantically equivalent queries has the lowest cost, that query can be stored for later execution, or executed immediately. Overall the techniques described herein enable lower cost query processing.

Hardware Overview

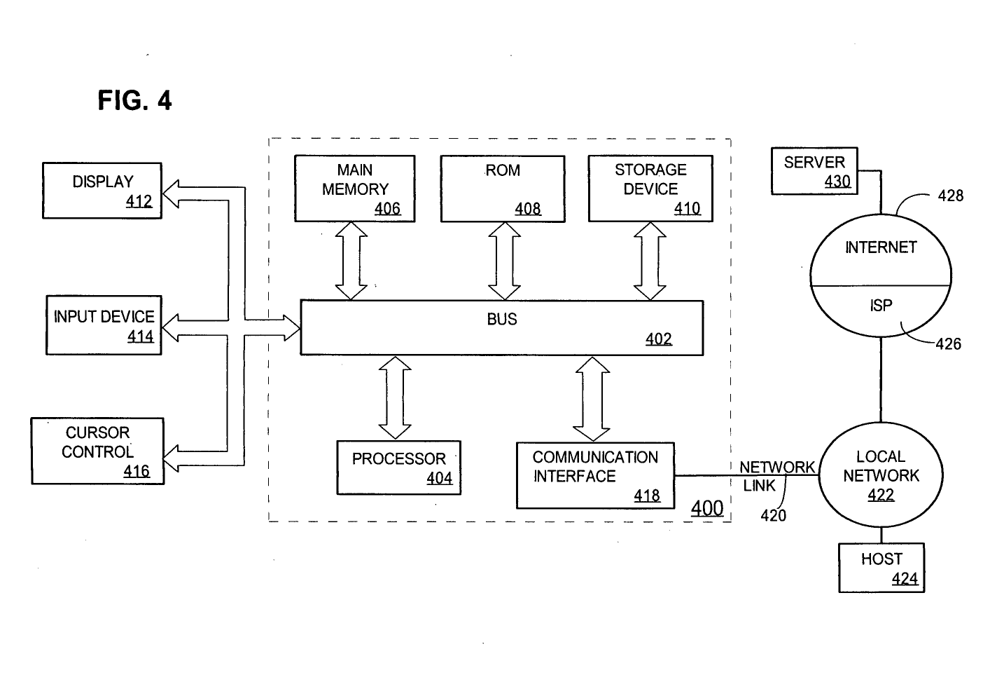

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing instructions to processor 404 for execution. Such a medium may take many forms, including but not limited to, non-volatile media, volatile media, and transmission media. N on-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infrared data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method of processing a query comprising the machine-implemented steps of:
determining a first cost based on the query;
if the query has a subquery, performing the steps of:
performing a first unnesting operation on the subquery;
generating a second query based on the query and the first unnesting operation;
determining a second cost based on the second query;
determining whether the second query comprises a mergeable view;
if the second query comprises a mergeable view, performing the steps of:
performing a first view merge transformation on the second query;
generating a third query based on the second query and the first view merge transformation;
determining a third cost based on the third query; and
choosing an output query from among a set of semantically equivalent queries based on costs associated with one or more queries from the set of semantically equivalent queries, wherein the set of semantically equivalent queries includes at least two of the query, the second query, and the third query.

2. The method of claim 1, further comprising the steps of:
if the query has a second subquery, performing the steps of:
generating a fourth query based on the query and performing no unnesting operations on the subquery and the second subquery;
determining a fourth cost based on the fourth query;
performing a second unnesting operation on the second subquery;
generating a fifth query based on the fourth query and the second unnesting operation;
determining a fifth cost based on the fifth query;
determining whether the fifth query comprises a mergeable view;
if the fifth query comprises a mergeable view, performing the steps of:
performing a second view merge transformation on the fifth query;
generating a sixth query based on the fifth query and the second view merge transformation;
determining a sixth cost based on the sixth query; and
wherein the set of semantically equivalent queries also includes the fourth query, the fifth query, and the sixth query.

3. The method of claim 2, further comprising the steps of:
if the query has the second subquery, performing the steps of:
generating a seventh query based on the sixth query and the first unnesting operation;
determining a seventh cost based on the seventh query;
determining whether the seventh query comprises a mergeable view;
if the seventh query comprises a mergeable view, performing the steps of:
performing a third view merge transformation on the seventh query;
generating an eighth query based on the seventh query and the third view merge transformation;
determining an eighth cost based on the eighth query; and
the set of semantically equivalent queries also includes the seventh query, and the eighth query.

4. The method of claim 1, wherein the second query is a Structured Query Language (SQL) query, and wherein the step of determining whether the second query comprises a mergeable view comprises determining whether the second query includes an inline view that contains a SQL GROUP BY clause.

5. The method of claim 1, wherein the second query is a SQL query, and wherein the step of determining whether the second query comprises a mergeable view comprises determining whether the second query includes an inline view that contains a DISTINCT key word.

6. The method of claim 1, wherein the second query is a SQL query, and wherein the step of determining whether the second query comprises a mergeable view comprises determining whether the second query includes an inline view that contains a SQL MAX function.

7. The method of claim 1, wherein the second query is a SQL query, and wherein the step of determining whether the second query comprises a mergeable view comprises determining whether the second query includes an inline view that contains a SQL MIN function.

8. The method of claim 1, wherein the second query is a SQL query, and wherein the step of determining whether the second query comprises a mergeable view comprises determining whether the second query includes an inline view that contains a SQL SUM function.

9. The method of claim 1, wherein the step of determining whether the second query comprises a mergeable view comprises determining whether the second query includes an inline view that contains an aggregation function.

10. The method of claim 1, further comprising the steps of:
receiving a request from a sender to execute the query;
if the query has a subquery, executing the output query; and
returning results of the executing step to the sender.

11. The method of claim 1, wherein the steps of the method are performed multiple times and the set of semantically equivalent queries comprises all semantically equivalent queries that can be determined for the query by a query-processing unit.

12. The method of claim 1, wherein the steps of the method are performed one or more times for each query block in the query; and set of semantically equivalent queries comprises a particular query that contains a lowest-cost alternative form for each query block in the query; and wherein choosing the output query comprises choosing the particular query.

13. The method of claim 1, wherein the subquery is one of multiple subqueries in the query, and wherein costs are determined for multiple semantically equivalent queries, wherein each semantically equivalent query is generated based on a different combination of original subqueries, unnesting operations, and view merge transformations than each other semantically equivalent query, and wherein the set of semantically equivalent queries includes the multiple semantically equivalent queries.

14. A machine-readable medium carrying one or more sequences of instructions which, when executed by one or more processors, causes the one or more processors to perform the method recited in claim 1.

15. A machine-readable medium carrying one or more sequences of instructions which, when executed by one or more processors, causes the one or more processors to perform the method recited in claim 2.

16. A machine-readable medium carrying one or more sequences of instructions which, when executed by one or more processors, causes the one or more processors to perform the method recited in claim 3.

17. A machine-readable medium carrying one or more sequences of instructions which, when executed by one or more processors, causes the one or more processors to perform the method recited in claim 4.

18. A machine-readable medium carrying one or more sequences of instructions which, when executed by one or more processors, causes the one or more processors to perform the method recited in claim 5.

19. A machine-readable medium carrying one or more sequences of instructions which, when executed by one or more processors, causes the one or more processors to perform the method recited in claim 6.

20. A machine-readable medium carrying one or more sequences of instructions which, when executed by one or more processors, causes the one or more processors to perform the method recited in claim 7.

21. A machine-readable medium carrying one or more sequences of instructions which, when executed by one or more processors, causes the one or more processors to perform the method recited in claim 8.

22. A machine-readable medium carrying one or more sequences of instructions which, when executed by one or more processors, causes the one or more processors to perform the method recited in claim 9.

23. A machine-readable medium carrying one or more sequences of instructions which, when executed by one or more processors, causes the one or more processors to perform the method recited in claim 10.

24. A machine-readable medium carrying one or more sequences of instructions which, when executed by one or more processors, causes the one or more processors to perform the method recited in claim 11.

25. A machine-readable medium carrying one or more sequences of instructions which, when executed by one or more processors, causes the one or more processors to perform the method recited in claim 12.

26. A machine-readable medium carrying one or more sequences of instructions which, when executed by one or more processors, causes the one or more processors to perform the method recited in claim 13.
